(19) United States
(12) Patent Application Publication
(10) Pub. No.: US 2023/0191733 A1
(43) Pub. Date: Jun. 22, 2023

(54) FULLY AUTOMATED BEAD FILLER PRODUCTION LINE SYSTEM AND FULLY AUTOMATED TIRE BEAD MOLDING AND ATTACHING METHOD

(71) Applicant: Guilin Rubber Industry R&D Institute Co., Ltd., Guilin, Guangxi (CN)

(72) Inventors: Yilin CHEN, Guilin, Guangxi (CN); Xiaojun LIU, Guilin, Guangxi (CN); Jun ZHANG, Guilin, Guangxi (CN); Youzhu ZHENG, Guilin, Guangxi (CN); Zhaoyuan QIN, Guilin, Guangxi (CN)

(21) Appl. No.: 17/996,236

(22) PCT Filed: Apr. 14, 2021
(86) PCT No.: PCT/CN2021/087298

§ 371 Date: Dec. 27, 2022

(30) Foreign Application Priority Data
Apr. 15, 2020 (CN) 202010292632.5

(51) Int. Cl. B29D 30/48

(52) U.S. Cl. CPC B29D 30/48; B29D 2030/487

(57) ABSTRACT

A fully automated bead filler production line system and a fully automated bead filler molding and attaching method, implementing highly efficient production of bead filler in order to solve the problem in traditional production lines of large occupied area and low efficiency. To achieve said goal, the solution is to provide a fully automated bead filler production line system, comprising: a bead filler molding processing section, a functional auxiliary section, a filler and bead molding processing section, and automated material flow sections. The bead filler molding processing section, the functional auxiliary section, and the filler and bead molding processing section are sequentially linked, and two material flow sections are provided, on either side of the filler and bead molding processing system respectively.

### FIELD

The present disclosure relates to a field of production of rubber tires, and more particularly to a system of a fully automatic production line of a bead filler and a fully automatic bead molding and attaching method.

### BACKGROUND

With the develop of the rubber industry, the production process of the rubber product has more and more requirements for the mechanical equipment of the rubber, and a low energy consumption, a low noise, zero pollution, a high efficiency, a high quality and a low cost are the trends of today's rubber equipment development.

The bead filler production line is an extremely important part of the rubber tire production process, the known production equipment has a scattered layout, does not consider automation requirements for docking among various processes, involves too much manual intervention, provides a low efficiency and has a complicated production management, which cannot meet the requirements of the digital and intelligent production of the tire.

CN110126319A discloses a bead filler production line, including a cooling storage device, a feeding device, a bead filler molding drum, a bead filler attaching device, and a bead filler rolling device. The feeding device is arranged at a discharging end of the cooling storage device, the bead filler molding drum is opposite to the bead filler attaching device, a joint surface of the bead filler molding drum and the bead filler attaching device is the discharging end of the feeding device, and the bead filler rolling device is arranged below the bead filler attaching device. The cooling storage device of this invention realizes the low-temperature cooling and shaping of the bead filler, the feeding device realizes the automatic feeding to the bead filler molding drum through suction by a vacuum chuck, and the feeding is controlled by a cylinder. The bead filler molding drum, the bead filler attaching device, the bead filler rolling device are driven by a servo motor, the shaping speed is fast and the stopping position is accurate. The rolling mechanism is used for exhausting, compacting and shaping rolling after the complexing of the bead wire and the bead filler, ensuring the effective attaching of the bead filler and the bead wire, but this invention has a low degree of digitalization and automation and a low efficiency.

Thus, it is a technical problem to be solved urgently to provide a system of a fully automatic production line of a bead filler and a fully automatic molding method for a bead filler in a field of production of rubber tires.

### SUMMARY

An object of the present disclosure is to provide a system of a fully automatic production line of a bead filler and a fully automatic bead filler molding method, which realize an efficient production of the bead filler, so as to solve the problems existing in a traditional production line, such as too much manual intervention, a low efficiency and a complicated production management.

An embodiment of an aspect of the present disclosure provides a system of a fully automatic production line of a bead filler, which includes a bead filler extruding and molding process part, a functional auxiliary part, a bead molding process part and an automatic logistics part; the bead filler extruding and molding process part, the functional auxiliary part and the bead molding process part are connected in sequence, two automatic logistics systems are provided and arranged at two sides of the molding process system of the bead with the bead filler; the bead filler extruding and molding process part includes a bead filler complex extruder and an automatic feeder, and the bead filler complex extruder is configured to plasticize and then complex a rubber sheet conveyed from the automatic feeder and used for producing a bead filler strip to obtain a required finished product of the bead filler; the functional auxiliary part includes a receiving and forced-contracting device, a continuous weighing device, a width measuring device, a spiral cooling device, an exhaust line pressing device and an unqualified-product marking device, which are configured to be increased or decreased according to different required processes; the bead molding process part includes a servo feeding device, an attaching drum device, a laminating mechanism and an attaching chuck device seamlessly connected in sequence, and two groups of the servo feeding devices, the attaching drum devices, the laminating mechanisms and the attaching chuck devices are provided and symmetrically arranged along a central axis; the automatic logistics system includes an articulated robot, an automatic bead wire feeding device, a bead stacking and conveying device, and a spacer conveying roller table.

Optionally, a storage device is arranged between the bead molding process part and the functional auxiliary part, the storage device is configured to meet a requirement of an intermittent operation of bead attaching, so that the bead filler extruding and molding process part is configured to operate continuously.

Optionally, the servo feeding device includes a main pneumatic frame, a traversing assembly, a conveying roller table, a cutting part and a delivery device.

Optionally, the attaching drum device includes a fixed base, a rotary box and an attaching drum.

Optionally, the laminating mechanism includes a laminating slice roller and a laminating cylinder.

Optionally, the attaching chuck device includes an attaching chuck A, an attaching chuck B and a rotary switching device, the attaching drum A and the attaching drum B are connected to the rotary switching device, and the rotary switching device is configured to rotate 180° horizontally.

Optionally, the bead stacking and conveying system includes three stations, which are a waiting station, a stacking station and a finishing station, each station is provided with a stacking trolley. The bead stacking and conveying system further includes a vehicle roller table and a stacking assembly; the spacer conveying roller table includes two stations, which are a spacer manual stacking station and a spacer grabbing station.

An embodiment of a second aspect of the present disclosure provides a fully automatic bead molding and attaching method for a system of a fully automatic production line of a bead filler, which includes the following steps.

At step 101, i.e. a molding process of the bead filler, an upper bead filler, a lower bead filler and a filling rubber sheet are complexed in a bead filler complex extruder, and then are continuously extruded and molded.

At step 102, the molded bead filler is transferred to a functional auxiliary part through a receiving and forced-contracting device.

At step 103, i.e. a machining process of the bead filler, the bead filler enters the functional auxiliary part, and passes through a continuous weighing device, a width measuring device, an exhaust line pressing device, an unqualified-product marking device, and a spiral cooling device in sequence, which steps are configured to be increased or decreased according to different required processes.

At step 104, i.e. a molding process of a bead with the bead filler, a step of winding the bead filler, a step of laminating a joint of a body of the bead filler and a step of flipping, erecting and molding are included.

At the step of winding the bead filler, the bead filler is continuously conveyed by a conveying roller table on a servo feeding device, a delivery device absorbs by vacuum, lifts and delivers a head part of the bead filler to a designated position on an attaching drum, the attaching drum rotates to wind the body of the bead filler, a cutting part cuts the bead filler transversely when a set length is reached, the delivery device absorbs by vacuum, lifts and delivers a tail part of the bead filler to the attaching drum to be engaged with the head part of the bead filler, and a pre-laminating mechanism preliminarily laminates the joint of the bead filler on the attaching drum.

At the step of laminating the joint of the body of the bead filler, the winded and closed cylindrical rubber strip is switched by rotation to a flipping and erecting position, the attaching drum rotates the joint to an initial laminating angle, the laminating mechanism then presses down a laminating slice roller, and the attaching drum rotates a certain angle to ensure that the laminating slice roller laminates the whole joint.

At the step of flipping, erecting and molding, an attaching chuck A and an attaching chuck B are pre-provided with bead wires of corresponding specifications, the attaching chuck A extends out to be butted with the attaching drum into a whole, the attaching drum is driven by a cylinder, the bead filler after being winded and laminated is flipped and erected onto the bead wire on the attaching chuck to complete the molding of the bead with the bead filler; a rotary switching device rotates 180° to switch positions of the attaching chuck A and the attaching chuck B.

At step 105, i.e. a logistics procedure, an articulated robot is in charge of loading the bead wire, transferring the bead and stacking a spacer, the articulated robot grabs and transfers the bead on the attaching chuck A to a stacking assembly of a bead stacking and conveying system, and then the stacking assembly completes the overturning of the bead; the stacking assembly places the beads one by one on a stacking trolley at a stacking station, the articulated robot grabs the spacer from a spacer placement roller table and places the spacer on the bead at the same time, to realize the spaced stacking of the beads, the stacking trolley is manually pushed into the bead stacking and conveying system, the stacking trolley is driven by a vehicle roller table to pass through a waiting station, the stacking station and a finishing station in sequence, and the fully loaded stacking trolley is unloaded out of the conveying system at the finishing station; the articulated robot grabs the bead wire from an automatic bead wire feeding device and places the bead wire on the attaching chuck A.

The present disclosure has the following advantages:
1. the space utilization rate is high, and the process can be flexibly adjusted according to the processing requirements;
2. the servo feeding system has a function of an accurate positioning deviation correction, and all the conveying and cutting adopt the servo control to ensure the accuracy and reliability of the feeding course, and achieve the digital control of the complete formula;
3. the attaching drum system adopts a form of operation with a double-station switching, to perform the automatic winding and closing as well as flipping, erecting and molding respectively, thus improving the production efficiency.

Additional aspects and advantages of the present disclosure will be set forth in part in the following description, and in part will be apparent from the following description, or may be learned by practice of the present disclosure.

### BRIEF DESCRIPTION OF THE DRAWINGS

The above and/or additional aspects and advantages of the present disclosure will become apparent and accessible from the following descriptions of the embodiments made with reference to the accompanying drawings, in which:

FIG. 1 is a schematic view of a system of a fully automatic production line of a bead filler according to an embodiment of the present disclosure;

FIG. 2 is a schematic view of a servo feeding device according to an embodiment of the present disclosure;

FIG. 3 is a schematic view of an attaching chuck device according to an embodiment of the present disclosure;

FIG. 4 is a schematic view of an attaching drum device according to an embodiment of the present disclosure;

FIG. 5 is flow chart of a fully automatic molding method for a system of a fully automatic production line of a bead filler according to an embodiment of the present disclosure.

As shown in the drawings, 1—bead filler complex extruder, 2—receiving and forced-contracting device, 3—continuous weighing device, 4—exhaust line pressing device, 5—unqualified—product marking device, 7—spiral cooling device, 8—storage device, 9—servo feeding device, 91—main pneumatic frame, 92—traversing assembly, 93—cutting part, 94—delivery device, 95—conveying roller table, 10—attaching drum device, 11—laminating mechanism, 12—attaching chuck device, 121—attaching chuck A, 122—attaching chuck B, 123—rotary switching device, 13—automatic bead wire feeding device, 14—articulated robot, 15—bead stacking and conveying device, 16—spacer conveying roller table, a—receiving device.

### DETAILED DESCRIPTION

Reference will be made in detail to illustrative embodiments of the present disclosure, examples of which are shown in the accompanying drawings. When the following descriptions refer to the accompany drawings, the same reference numerals in different drawings indicate the same or similar elements, unless specified or limited otherwise. The implementations described in the following illustrative embodiments do not represent all the embodiments consistent with the embodiments of the present disclosure. On the contrary, they are only examples of devices and methods consistent with some aspects of the embodiments of the present disclosure as detailed in the appended claims.

Terms used in the embodiments of the present disclosure are only for the purpose of describing specific embodiments, and are not intended to limit the embodiments of the present disclosure. The singular forms “a” and “the” used in the embodiments of the present disclosure and the appended claims are also intended to include the plural forms, unless the context clearly indicates other meanings. It should also be understood that the term “and/or” used herein refers to and includes any or all possible combinations of one or more associated listed items.

It should be understood that although the terms “first”, “second”, “third”, etc. may be used to describe various information in the embodiments of the present disclosure, these information should not be limited to these terms. These terms are only used to distinguish the same type of information from each other. For example, without departing from the scope of the embodiments of the present disclosure, the first information may also be called the second information, and similarly, the second information may also be called the first information. Depending on the context, the words “if” and “in case” as used here can be interpreted as “when” or “while” or “in response to determination”.

Embodiments of the present disclosure are described in detail below, examples of which are shown in the accompanying drawings, in which the same or similar reference numerals indicate the same or similar elements throughout. The embodiments described below with reference to the accompanying drawings are illustrative and are intended to explain the present disclosure, but should not be construed as limitations of the present disclosure.

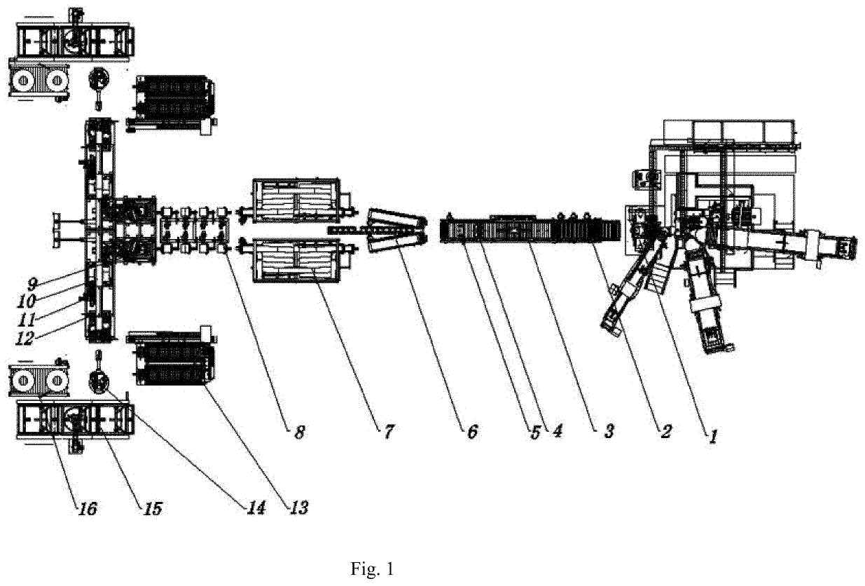

As shown in FIG. 1, a system of a fully automatic production line of a bead filler includes: a bead filler extruding and molding process part, a functional auxiliary part, a bead molding process part and an automatic logistics part. The bead filler extruding and molding process part, the functional auxiliary part and the bead molding process part are connected in sequence, and two automatic logistics systems are provided and arranged at two sides of the molding process system of the bead with the bead filler, respectively.

The bead filler extruding and molding process part includes a bead filler complex extruder 1, and the bead filler complex extruder 1 can plasticize and then complex a rubber sheet used for producing a bead filler strip to obtain a required finished product of the bead filler. The bead filler complex extruder 1 can realize the built-in complexing and then the extrusion of a hard rubber, a soft rubber and a buffer rubber of the bead filler. The built-in complexing and then the extrusion can firmly connect the hard rubber, the soft rubber and the buffer rubber of the bead filler together, and accurately extrude the same according to the required section of the product.

The functional auxiliary part includes a receiving and forced-contracting device, a continuous weighing device 3, a width measuring device, a spiral cooling device 7, an exhaust line pressing device 4, an unqualified-product marking device 5 connected in sequence. Since a production speed of the functional auxiliary part is substantially constant and continuous, and a production speed of the bead molding process part is a multistage variable speed, a progress of finishing the attaching of one bead is an intermittent process. Thus, a storage device is arranged before butting of the functional auxiliary part and the bead molding process part, for a buffer transition of a rubber material to guarantee a continuous production. The functional auxiliary part can realize the functions of the continuous receiving, cooling and shaping of the bead filler, and the intermittent supply to the bead molding process part, etc. The spiral cooling device 7 adopts a spiral cooling structure, which can greatly reduce an occupied area of an auxiliary line, and adopts a forced air cooling, so as to meet a cooling capacity and also avoid a qualitative change of the rubber material.

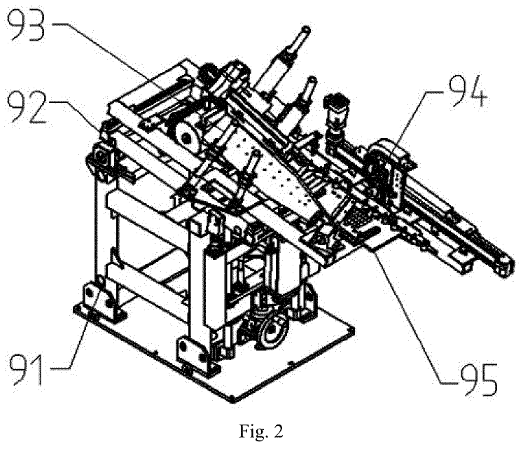

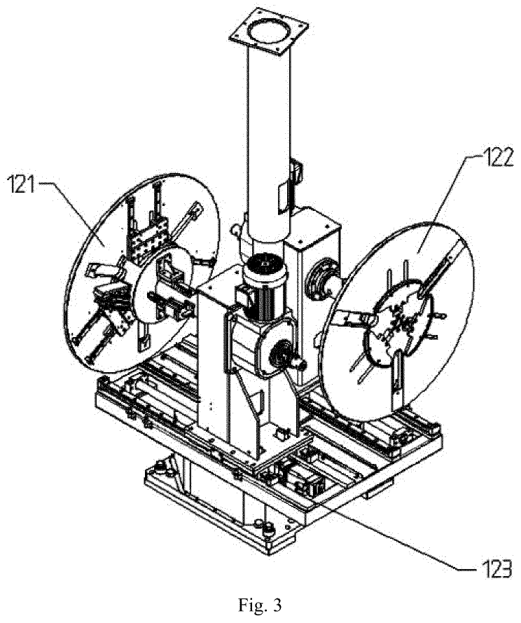

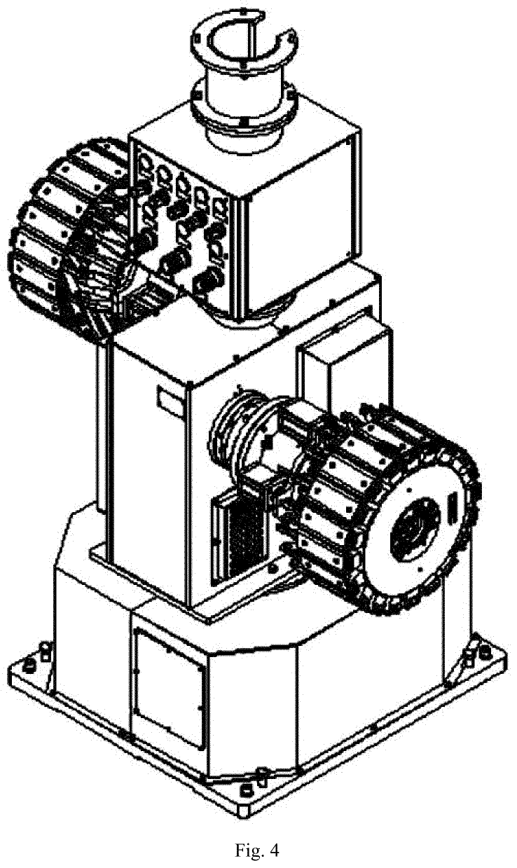

As shown in FIG. 2, FIG. 3 and FIG. 4, the bead molding process part includes a servo feeding device 9, an attaching drum device 10, a laminating mechanism 11 and an attaching chuck device 12 connected in sequence, and two groups of the servo feeding devices 9, the attaching drum devices 10, the laminating mechanisms 11 and the attaching chuck devices 12 are provided and symmetrically arranged along a central axis. The servo feeding device 9 includes a main pneumatic frame 91, a traversing assembly 92, a conveying roller table 95, a cutting part 93 and a delivery device 94. The attaching drum device 10 includes a fixed base, a rotary box and an attaching drum. The laminating mechanism 11 includes a laminating slice roller and a laminating cylinder. The attaching chuck device 12 includes an attaching chuck A121, an attaching chuck B122 and a rotary switching device 123, the attaching chuck A121 and the attaching chuck B122 are connected to the rotary switching device 123, and the rotary switching device 123 can rotate 180° horizontally. The bead molding process part is a core part for the fully automatic production of the bead filler, and can realize the functions of the on-line cutting, conveying, automatic winding and closing, automatic joint laminating, flipping and erecting, and forming of the rubber material of the bead filler. The servo feeding device 9 has the function of the accurate positioning deviation correction, and all the conveying and cutting adopt the servo control to ensure the accuracy and reliability of the feeding course, and achieve the complete formulation. The servo feeding device 9 also has an automatic head and tail overlapping mechanism, which is the key to the fully automatic production. The servo feeding device 9 also realizes the tensioning and positioning of the rubber material in all the processes of cutting, head and tail conveying and the like through various mechanisms, which is the quality guarantee of the online continuous production of the bead filler. The attaching drum device 10 adopts a form of operation with a double-station switching, to perform the automatic winding as well as flipping, erecting and molding respectively, thus improving the production efficiency. The attaching drum device 10 adopts an adjustable mechanical drum, which can adopt to the production of products with various specifications within a certain range, thus greatly reducing the production cost. The speed matching between the attaching drum device 10 and the servo feeding device 9 is accomplished by servo, which improves the accuracy and stability of the product. The attaching drum device 10 cooperates with the attaching chuck device 12, and the bead filler of the bead is flipped, erected and formed by a coordinate conversion at a flipping and erecting side, which has the characteristics of the stability and reliability, the uniformity of the bead filler product and the high degree of coating a bead wire. The laminating mechanism 11 adopts a multi-piece press roller structure, which can automatically match with various specifications of the bead fillers and automatically complete the pressing of the joint. The attaching chuck device 12 adopts the form of operation with the double-station switching, is butted with the attaching drum on the flipping and erecting side and is butted with an articulated robot 14 on a loading and unloading side, thus improving the production efficiency.

The automatic logistics system includes an articulated robot 14, an automatic bead wire feeding device 13, a bead stacking and conveying device 15 and a spacer conveying roller table 16. The bead stacking and conveying system includes three stations, which are a waiting station, a stacking station and a finishing station, and each station is provided with a stacking trolley. The bead stacking and conveying system further includes a vehicle roller table and a stacking assembly. The spacer conveying roller table 16 includes two stations, which are a spacer manual stacking station and a spacer grabbing station. The automatic logistics system can realize the functions of the automatic loading of the bead wire, the automatic unloading of the bead filler of the bead, the automatic stacking of the bead and the spacer, the automatic conveying of the stacking trolley, the automatic conveying of the spacer and the docking with a MES system of a factory.

The system of the fully automatic production line of the bead filler also has a perfect control program system, including a linkage control of various parts of the production line, a formula control of products with different specifications, a manual operation function, a maintenance and debugging function, a safety protection function, etc.

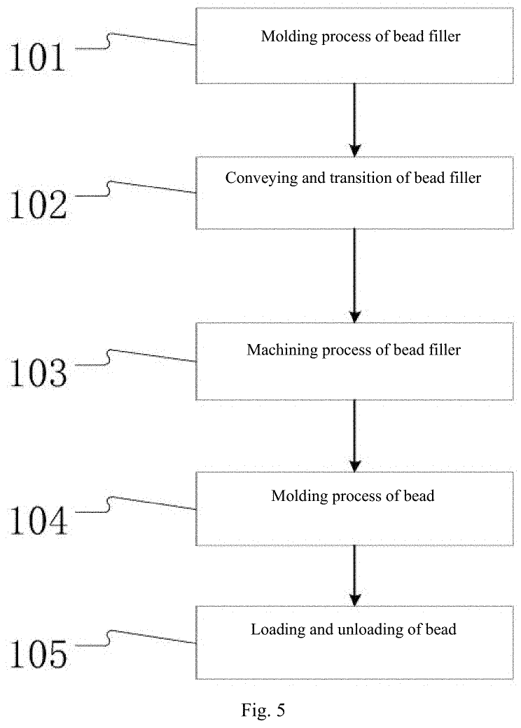

As shown in FIG. 5, a fully automatic molding method for a system of a fully automatic production line of a bead filler, includes following steps.

At step 101, i.e. a molding process of the bead filler, an upper bead filler, a lower bead filler and a filling rubber sheet are complexed in a bead filler complex extruder 1, and then are continuously extruded and molded.

At step 102, the molded bead filler is transferred to a functional auxiliary part through a receiving and forced-contracting device 2.

At step 103, i.e. a machining process of the bead filler, the bead filler enters the functional auxiliary part, and passes through a continuous weighing device, a width measuring device, an exhaust line pressing device, an unqualified-product marking device, and a spiral cooling device in sequence, which steps can be increased or decreased according to different required processes.

At step 104, i.e. a molding process of a bead with the bead filler, a step of winding the bead filler, a step of laminating a joint of a body of the bead filler and a step of flipping, erecting and molding are included.

At the step of winding the bead filler, the bead filler is continuously conveyed by a conveying roller table 95 on a servo feeding device 9, a delivery device 94 lifts and delivers a head part of the bead filler to a designated position on an attaching drum, the attaching drum rotates to wind the body of the bead filler, a cutting part 93 cuts the bead filler transversely, the delivery device 94 delivers a tail part of the bead filler to the attaching drum to be engaged with the head part of the bead filler, and a pre-laminating mechanism preliminarily laminates the joint of the bead filler on the attaching drum.

At the step of laminating the joint of the body of the bead filler, the winded and closed cylindrical rubber strip is switched by rotation to a flipping and erecting position, the attaching drum rotates the joint to an initial laminating angle, the laminating mechanism 11 then presses down a laminating slice roller, and the attaching drum rotates a certain angle to ensure that the laminating slice roller laminates the whole joint.

At the step of flipping, erecting and molding, an attaching chuck A121 and an attaching chuck B122 are pre-provided with bead wires of corresponding specifications, the attaching chuck A121 extends out to be butted with the attaching drum into a whole, the attaching drum is driven by a cylinder, the bead filler after being winded and laminated is flipped and erected onto the bead wire on the attaching chuck to complete the molding of the bead with the bead filler; a rotary switching device 123 rotates 180° to switch positions of the attaching chuck A121 and the attaching chuck B122.

At step 105, i.e. a logistics procedure, an articulated robot 14 is in charge of loading the bead wire, transferring the bead and stacking a spacer, the articulated robot 14 transfers the bead on the attaching chuck A121 to a stacking assembly of a bead stacking and conveying system, and then the stacking assembly completes the overturning of the bead; the stacking assembly then places the beads one by one on a stacking trolley at a stacking station, the articulated robot 14 grabs the spacer from a spacer placement roller table and places the spacer on the bead at the same time, to realize the spaced stacking of the beads, the stacking trolley is manually pushed into the bead stacking and conveying system, the stacking trolley is driven by a vehicle roller table to pass through a waiting station, the stacking station and a finishing station in sequence, and the fully loaded stacking trolley is unloaded at the finishing station; the articulated robot 14 grabs the bead wire from an automatic bead wire feeding device 13 and places the bead wire on the attaching chuck A121.

Those skilled in the art will easily think of other embodiments of the present disclosure after considering the specification and practicing the invention disclosed here. The present disclosure is intended to cover any variations, uses or adaptations of the present disclosure, which follow the general principles of the present disclosure and include common knowledge or common technical means in the technical field not disclosed in the present disclosure. The specification and embodiments are to be regarded as examples only, and the true scope and spirit of the present disclosure are indicated by the following claims.

It should be understood that the present disclosure is not limited to the precise structure described above and shown in the drawings, and various modifications and changes can be made without departing from the scope of the present disclosure. The scope of the present disclosure is limited only by the appended claims.

What is claimed is:

1. A system of a fully automatic production line of a bead filler, comprising a bead filler extruding and molding process part, a functional auxiliary part, a bead molding process part and an automatic logistics part, wherein the bead filler extruding and molding process part, the functional auxiliary part and the bead molding process part are connected in sequence, and two automatic logistics systems are provided and arranged at two sides of the bead molding process system, respectively;
the bead filler extruding and molding process part comprises a bead filler complex extruder (1) and an automatic feeder, and the bead filler complex extruder (1) is configured to plasticize and then complex a rubber sheet conveyed from the automatic feeder and used for producing a bead filler strip to obtain a required finished product of the bead filler;
the functional auxiliary part comprises a receiving and forced-contracting device (2), a continuous weighing device (3), a width measuring device, a spiral cooling device (7), an exhaust line pressing device (4) and an unqualified-product marking device (5), which are configured to be increased or decreased according to different required processes;
the bead molding process part includes a servo feeding device (9), an attaching drum device (10), a laminating mechanism (11) and an attaching chuck device (12) connected in sequence, and two groups of the servo feeding devices (9), the attaching drum devices (10), the laminating mechanisms (11) and the attaching chuck devices (12) are provided and symmetrically arranged along a central axis; and
the automatic logistics system comprises an articulated robot (14), an automatic bead wire feeding device (13), a bead stacking and conveying device (15), and a spacer conveying roller table (16).

2. The system of the fully automatic production line of the bead filler according to claim 1, wherein a storage device (8) is arranged between the bead molding process part and the functional auxiliary part, the storage device (8) is configured to meet a requirement of an intermittent operation of bead attaching, so that the bead filler extruding and molding process part is configured to operate continuously.

3. The system of the fully automatic production line of the bead filler according to claim 1, wherein the servo feeding device (9) comprises a main pneumatic frame (91), a traversing assembly (92), a conveying roller table (95), a cutting part (93) and a delivery device (94).

4. The system of the fully automatic production line of the bead filler according to claim 1, wherein the attaching drum device (10) comprises a fixed base, a rotary box and an attaching drum.

5. The system of the fully automatic production line of the bead filler according to claim 1, wherein the laminating mechanism (11) comprises a laminating slice roller and a laminating cylinder.

6. The system of the fully automatic production line of the bead filler according to claim 1, wherein the attaching chuck device (12) comprises an attaching chuck A(121), an attaching chuck B(122) and a rotary switching device (123), the attaching drum A and the attaching drum B are connected to the rotary switching device (123), and the rotary switching device (123) is configured to rotate 180° horizontally.

7. The system of the fully automatic production line of the bead filler according to claim 1, wherein the bead stacking and conveying system comprises three stations, which are a waiting station, a stacking station and a finishing station, each station is provided with a stacking trolley, the bead stacking and conveying system further comprises a vehicle roller table and a stacking assembly; the spacer conveying roller table (16) comprises two stations, which are a spacer manual stacking station and a spacer grabbing station.

8. A fully automatic bead molding and attaching method for a system of a fully automatic production line of a bead filler, comprising:
step 101, a molding process of the bead filler: an upper bead filler, a lower bead filler and a filling rubber sheet are complexed in a bead filler complex extruder (1), and then are continuously extruded and molded;
step 102: the molded bead filler is transferred to a functional auxiliary part through a receiving and forced-contracting device (2);
step 103, a machining process of the bead filler: the bead filler enters the functional auxiliary part, and passes through a continuous weighing device (3), a width measuring device, an exhaust line pressing device (4), an unqualified-product marking device (5), and a spiral cooling device (7) in sequence, which steps are configured to be increased or decreased according to different required processes;
step 104, a molding process of a bead with the bead filler: a step of winding the bead filler, a step of laminating a joint of a body of the bead filler and a step of flipping, erecting and molding are comprised,
wherein, at the step of winding the bead filler, the bead filler is continuously conveyed by a conveying roller table (95) on a servo feeding device (9), a delivery device (94) absorbs by vacuum, lifts and delivers a head part of the bead filler to a designated position on an attaching drum, the attaching drum rotates to wind the body of the bead filler, a cutting part (93) cuts the bead filler transversely when a set length is reached, the delivery device (94) absorbs by vacuum, lifts and delivers a tail part of the bead filler to the attaching drum to be engaged with the head part of the bead filler, and a pre-laminating mechanism preliminarily laminates the joint of the bead filler on the attaching drum;
at the step of laminating the joint of the body of the bead filler, the winded and closed cylindrical rubber strip is switched by rotation to a flipping and erecting position, the attaching drum rotates the joint to an initial laminating angle, the laminating mechanism (11) then presses down a laminating slice roller, and the attaching drum rotates a certain angle to ensure that the laminating slice roller laminates the whole joint;
at the step of flipping, erecting and molding, an attaching chuck A(121) and an attaching chuck B(122) are pre-provided with bead wires of corresponding specifications, the attaching chuck A(121) extends out to be butted with the attaching drum into a whole, the attaching drum is driven by a cylinder, the bead filler after being winded and laminated is flipped and erected onto the bead wire on the attaching chuck to complete the molding of the bead with the bead filler; a rotary switching device (123) rotates 180° to switch positions of the attaching chuck A(121) and the attaching chuck B(122); and
step 105, a logistics procedure: an articulated robot (14) is in charge of loading the bead wire, transferring the bead and stacking a spacer, the articulated robot (14) grabs and transfers the bead on the attaching chuck A(121) to a stacking assembly of a bead stacking and conveying system, and the stacking assembly completes the overturning of the bead; the stacking assembly places the beads one by one on a stacking trolley at a stacking station, the articulated robot (14) grabs the spacer from a spacer placement roller table and places the spacer on the bead at the same time, to realize the spaced stacking of the beads, the stacking trolley is manually pushed into the bead stacking and conveying system, the stacking trolley is driven by a vehicle roller table to pass through a waiting station, the stacking station and a finishing station in sequence, and the fully loaded stacking trolley is unloaded out of the conveying system at the finishing station; the articulated robot (14) grabs the bead wire from an automatic bead wire feeding device (13) and places the bead wire on the attaching chuck A(121).
